(19) United States
(12) Patent Application Publication
(10) Pub. No.: US 2025/0174881 A1
(43) Pub. Date: May 29, 2025

(54) COMMUNICATION DEVICE

(71) Applicant: Tusas- Turk Havacilik Ve Uzay Sanayii Anonim Sirketi, Kahramankazan (TR)

(72) Inventors: Abdullah GOZUM, Kahramankazan (TR); Oguzhan AKGOL, Kahramankazan (TR); Ömer Ozan KIRGIN, Kahramankazan (TR); Yusuf SEZGIN, Kahramankazan (TR)

(73) Assignee: Tusas- Turk Havacilik Ve Uzay Sanayii Anonim Sirketi, Kahramankazan (TR)

(21) Appl. No.: 18/957,960

(22) Filed: Nov. 25, 2024

(30) Foreign Application Priority Data
Nov. 27, 2023 (TR) 2023/015864

(51) Int. Cl. H01Q 1/34; H01Q 15/16

(52) U.S. Cl. CPC H01Q 1/34; H01Q 15/16

(57) ABSTRACT

The present invention relates to at least one buoy (2) made of flexible material to be positioned on the water surface (W), at least one inflation apparatus (3) that is located on the buoy (2) and allows the buoy (2) to be inflated, a first state (I) of the buoy (2), and a second state (II) in which the buoy (2) is inflated by injecting air into it by means of the inflation apparatus (3) to be positioned on the water surface (W).

### RELATED APPLICATION

This application claims the benefit of priority of Turkey Patent Application No. 2023/015864 filed on Nov. 27, 2023, the contents of which are incorporated by reference as if fully set forth herein in their entirety.

### FIELD AND BACKGROUND OF THE INVENTION

The present invention relates to a communication device that enables the establishment and maintenance of communication connections between submarines and vehicles on the sea.

Today, communication is provided by means of electromagnetic waves spread in the atmosphere. In this way, connections that enable fast communication are established by means of electromagnetic waves transmitted between antennas and satellites, telephones and base stations. However, due to the electromagnetic structure of salt water, which is very different from air, it is not possible for a system in the atmosphere to communicate directly with a system in the submarine. The main reason for this is that electromagnetic waves cannot propagate effectively enough in water at the frequencies used in secondary communication devices. For this reason, communication in submarine systems is provided by means of optical waves or sonar systems rather than electromagnetic waves (RF). Communication between the atmosphere and the submarine is provided by means of communication modules placed in buoy systems today.

In the Chinese utility model document numbered CN208399676U in the state of the art, a portable device used on water for radar and optical observation is mentioned. Within the scope of the utility model document, a portable device used for radar and optical observation which is developed due to the radar observation effect of the existing device not being good, and which comprises an inflatable ball, an inflator and a conductive surface, and an inflatable connection point placed on an outer surface of the inflatable ball is mentioned.

In the United States patent application document numbered US20150346726A1 in the state of the art, controllable and reconfigurable networked air-filled buoy systems capable of monitoring and maintaining communications on, below and above the surface of the ice or water are mentioned. It is mentioned that monitoring, communication, and positioning capabilities can be provided between surface communication nodes and vehicles and surface vehicles through the networked controllable buoy systems described in the patent document, and a controllable communication network that provides permanence can be created in water.

By means of the communication device developed with the present invention, transformations of communication waves are carried out on the sea surface in order to provide communication between the region above the sea and the submarine, and communication can be provided between the two environments.

Another aim of this invention is to provide communication between the atmosphere and the submarine with light, cheap and easily portable systems.

Another aim of the invention is to provide communication between the atmosphere and the submarine with systems that are easy to install and maintain.

### SUMMARY OF THE INVENTION

The communication device defined in the first claim and the claims dependent on this claim, which is realised in order to achieve the aim of the invention, comprises at least one buoy made of flexible material to be positioned by the user on water and/or ice, at least one inflation apparatus that is positioned on the buoy and allows the buoy to be inflated by filling it with air in a position predetermined by the user, a first state (I) in which the spherical buoy is compressed through the space inside the buoy, and a second state (II) in which air is injected into the compressed buoy by means of an inflation apparatus.

The communication device that is the subject of the invention comprises a flexible, inflatable, textile-formed buoy, and at least one reflector, which is independent of the outer surface of the buoy and only partially covers its inner surface, thus allows the electromagnetic waves transmitted from the air to the water or ice in the second state (II) to be detected on the buoy without any distortion. A reflector with high flexibility and conductivity is applied to the inner surface of the inflatable buoy that is in textile and non-woven form.

In one embodiment of the invention, the communication device comprises the reflector that made of material that is transparent to electromagnetic waves, is located on the inner surface (Z) of the buoy, is concave and forms a parabolic dish antenna when the buoy comes from the first state (I) to the second state (II), is a conductive paint or coating that allows almost any electromagnetic signal transmitted onto the buoy, which is made of material that is transparent to electromagnetic waves and has a transparent outer surface, to be detected. The dish antenna form is formed on the inner surface of the buoy opposite its outer surface that is in contact with water or ice in the second state (II).

In one embodiment of the invention, the communication device comprises at least one surface sensor (“Transceiver” or “Electromagnetic Communication Device”) that is positioned on the water or ice on the buoy and is not in contact with water or ice when the buoy is in the second state (II). By means of the surface sensor, electromagnetic waves or signals transmitted over water or ice are captured via a reflector on the buoy.

In one embodiment of the invention, the communication device comprises at least one underwater sensor (sonar) that is mounted on the buoy in the second state (II) and positioned to remain almost completely underwater, thus allows acoustic or optical signals transmitted under water or ice to be detected and captured on the buoy, and enables acoustic or optical signals to be transmitted under water or ice from the buoy.

In one embodiment of the invention, the communication device comprises at least one transmission line that is made of conductive paint and allows the electromagnetic signals transmitted to the buoy and captured by the surface sensor through the reflector to be transmitted from the inner surface of the buoy.

In one embodiment of the invention, the communication device comprises at least one converter unit, where the electromagnetic signal captured on the surface sensor is transmitted to be converted into an acoustic or optical signal after being transmitted by the transmission line. After being converted into an acoustic or optical wave by means of the converter unit, the signals are transmitted to the underwater sensor to be transmitted underwater. In the second state (II), the transducer unit is positioned on the concave reflector on the inner surface of the buoy, opposite the underwater sensor located on the surface that is in contact with water or ice, thus in the second state (II), allows the underwater sensor to remain almost completely submerged, while the surface sensor remains above the water without coming into contact with it.

In one embodiment of the invention, the communication device comprises an underwater sensor that allows the detection of acoustic or optical signals transmitted from under water or ice, the converter unit that converts the captured acoustic/optical signal transmitted from the underwater sensor into a signal with an electromagnetic waveform, at least one transmission line that allows the signal converted into an electromagnetic wave to be transmitted to the surface sensor, which allows it to be transmitted to the receiver by processing it in the converter unit, and a buoy that thus enables signals in the form of acoustic or optical waves transmitted from under water or ice to be transmitted over water or ice and to establish communication with vehicles under water or ice and on water or ice.

In one embodiment of the invention, the communication device comprises a surface sensor that is applied to the buoy by the user, is a conductive paint and remains on the water or ice in the second state (II).

In one embodiment of the invention, the communication device comprises at least one trigger sensor that is positioned on the buoy in connection with the inflation apparatus, triggers the inflation apparatus by sensing the contact of the buoy with the water and ice in the first state (I) and allows the buoy to switch to the second state (II).

In one embodiment of the invention, the communication device comprises at least one keel that is positioned on the buoy in order to prevent the centre of gravity created by the converter unit located inside the buoy from being affected by fluctuations on or under water or ice to prevent the position of the underwater sensor under water or ice and the position of the surface sensor on water or ice from changing in the second state (II).

### BRIEF DESCRIPTION OF THE SEVERAL VIEWS OF THE DRAWINGS

The communication device realised to achieve the aim of the present invention is shown in the attached figures, and of these figures;

FIG. 1 shows the schematic view of the buoy in the first state (I).

FIG. 2 shows the schematic view of the buoy in the second state (II).

FIG. 3 shows the schematic view of the buoy, surface sensor, underwater sensor, transmission line and reflector in the second state (II).

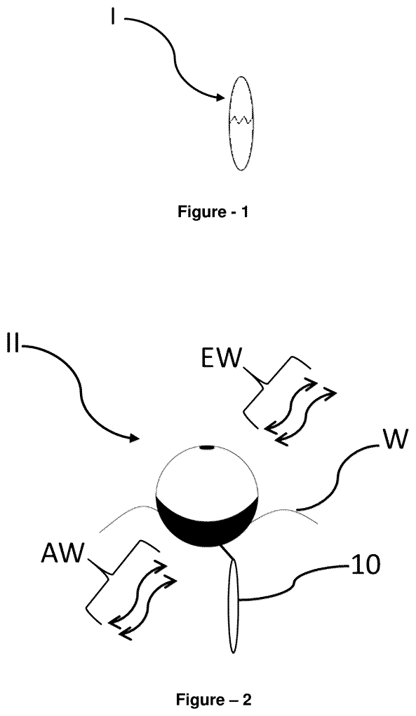

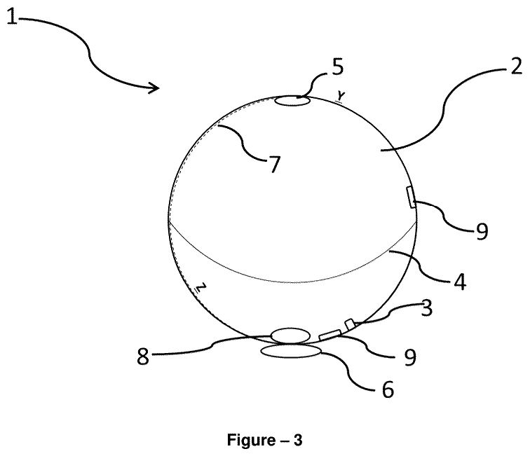

### DESCRIPTION OF SPECIFIC EMBODIMENTS OF THE INVENTION

The parts in the figures are numbered one by one and the equivalents of these numbers are given below.
1. Communication device
2. Buoy
3. Inflation apparatus
4. Reflector
5. Surface sensor
6. Underwater sensor
7. Transmission line
8. Converter unit
9. Trigger sensor
10. Keel
(I) First State
(II) Second State
(Z) Inner surface
(Y) Outer surface
(W) Water surface
(EW) Electromagnetic Wave
(AW) Optical or Acoustic Wave

The communication device (1) comprises at least one buoy (2) made of flexible material to be positioned on the water surface (W), at least one inflation apparatus (3) that is located on the buoy (2) and allows the buoy (2) to be inflated, a first state (I) of the buoy (2), and a second state (II) in which the buoy (2) is inflated by injecting air into it by means of the inflation apparatus (3) to be positioned on the water surface (W).

Said communication device (1) comprises the buoy (2) made almost entirely of dielectric material, and at least one reflector (4) that partially covers the inner surface (Z) of the buoy (2) and thus creates a conductive surface that allows the electromagnetic wave (EW) to be detected on the buoy (2) without distortion in the second state (II).

The buoy (2), which is made of flexible and transparent material against electromagnetic waves, is in a compressed form in the first state (I). When the buoy (2) is to be positioned on the water surface (W) or ice by the user, it is brought to the second state (II) by injecting air into the volume inside its compressed form by means of the inflation apparatus (3). By means of its production from light material, the buoy (2) is brought to a floating position on the water or ice surface.

The buoy (2), which is produced from flexible and preferably inflatable lightweight textile material, has dielectric properties. In this way, the buoy (2) can be kept light and compressible in the first state (I). In order to create a conductive surface suitable for electromagnetic waves (EW) on the buoy (2) made of dielectric material, the reflector (4) is positioned on the inner surface (Z) of the buoy (2). In order to prevent the reflector (4) from coming into contact with water and the loss of electromagnetic waves (EW) passing through the transparent outer surface (Y) to the inner surface (Z), the reflector (4) is located inside the buoy (2) in a way that partially covers the inner surface (Z) of the buoy (2) independently of the outer surface (Y).

In one embodiment of the invention, the communication device (1) comprises a reflector (4) that is made of flexible conductive paint, creates a concave dish antenna form on the inner surface (Z) of the buoy (2) in the second state (II), thus creates a surface capable of detecting electromagnetic waves (EW) on the buoy (2) enabling the detection of almost every transmitted electromagnetic wave (EW). By means of the reflector (4) made of conductive and flexible paint, the conductive surface can be preserved on the buoy (2) made of flexible and dielectric material in both the first state (I) and the second state (II), and in the second state (II), a parabolic or cross-sectional shape of parabola dish antenna form suitable for electromagnetic waves (EW) can be created on the buoy (2). By means of the concave, parabolic dish antenna form, almost every electromagnetic wave (EW) that passes through the transparent outer surface (Y) and enters the buoy (2) to be transmitted underwater is detected on the reflector (4) without any loss.

In one embodiment of the invention, the communication device (1) comprises at least one surface sensor (5) that is located on the buoy (2) and is positioned to remain on the water surface (W) in the second state (II), thus enables the electromagnetic waves (EW) transmitted over the water surface (W) to be captured and/or transmitted on the buoy (2). Electromagnetic signals transmitted over water or ice, for example from a manned or unmanned aerial vehicle, are detected and captured using the surface sensor (5) via the reflector (4) on the buoy (2). The aim is to position the surface sensor (5) so that it remains above the water or ice when the buoy (2) is in the second position (II). In this way, the electromagnetic waves (EW) transmitted over water or ice are captured without loss and the surface sensor (5) is prevented from being affected by elements that may block electromagnetic waves (EW) in water or ice, such as salt.

In one embodiment of the invention, the communication device (1) comprises at least one underwater sensor (6) that is located on the buoy (2) and is positioned to remain under the water surface (W) in the second state (II), thus enables the acoustic and/or optical waves (AW) transmitted from under the water surface (W) to be captured on the buoy (2) or the transmission of acoustic and/or optical waves (AW) from the buoy (2) to the underwater. By means of the underwater sensor (6), optical or acoustic waves (AW) transmitted by vehicles under water or ice can be detected on the buoy (2). The underwater sensor (6), which is preferably sonar, is positioned on the buoy (2) to remain under water or ice.

In one embodiment of the invention, the communication device (1) comprises at least one transmission line (7) that is produced from conductive paint and enables the transmission of electromagnetic waves (EW) captured on the buoy (2) using the surface sensor (5) via the reflector (4) from the inner surface (Z) of the buoy (2). The electromagnetic waves (EW) captured by the surface sensor (5) are carried by means of the transmission line (7) which is positioned on the inner surface (Z) of the buoy (2) and is independent of the outer surface (Y) of the buoy (2) in order to avoid loss. In the second state (II), the transmission line (7) is preferably located in a spherical form, extending along the entire length between the underwater sensor (6) and the surface sensor (5) which are positioned opposite each other on the inner surface (Z) of the buoy (2).

In one embodiment of the invention, the communication device (1) comprises at least one converter unit (8) that enables the electromagnetic waves (EW) carried on the buoy (2) and transmitted to the underwater sensor (6) via the transmission line (7) to be converted into acoustic/optical waves (AW), is located in the inner surface (Z) of the buoy (2) that is opposite to the outer surface (Y) that is in contact with the water in the second state (II), and thus allows the buoy (2) to remain balanced on the water surface by creating the centre of gravity in the second state (II). The converter unit (8) is positioned on in the inner surface (Z) of the buoy (2) that is opposite to the outer surface (Y) that is in contact with the water in the second state (II), in a way that it is connected to the underwater sensor (6) and the transmission line (7). In this way, when the buoy (2) switches from the first state (I) to the second state (II) by being triggered by the user or automatically, the underwater sensor (6) is positioned almost completely under the water surface (W) and the surface sensor (5) is positioned above the water surface (W) and the parabolic form of the reflector (4) is created on the inner surface (Z) of the buoy (2) so that it will be opposite to the surface sensor (5). The communication network between the surface and underwater vehicles, such as a manned/unmanned aerial vehicle and a manned/unmanned submarine, is provided by the converter unit (8) located on the buoy (2). The electromagnetic waves (EW) captured by the surface sensor (5) on the buoy (2) are transferred from the inner surface (Z) of the buoy (2) to the converter unit (8) using the transmission line (7). Within the converter unit (8), electromagnetic waves (EW) are converted into acoustic or optical waves (AW) and sent to the underwater sensor (6) to be transmitted under water or ice.

In an embodiment of the invention, the communication device (1) comprises an underwater sensor (6) that allows the detection of acoustic/optical waves (AW) transmitted from under the water surface (W), a converter unit (8) that converts the detected signals transmitted via the underwater sensor (6) into electromagnetic waves (EW), a transmission line (7) that allows the signals converted into electromagnetic waves (EW) to be transmitted to the surface sensor (5), and a buoy (2) that enables the electromagnetic waves (EW) transmitted via the transmission line (7) to be transmitted to the receiver via the surface sensor (5) and thus enables the establishment of an underwater-surface communication network. It is possible to capture the acoustic/optical waves (AW) transmitted from underwater via the buoy (2) with the underwater sensor (6) and to transmit them to the surface sensor (5) by converting them into electromagnetic waves (EW) and to send them to the receiver from the surface sensor (5) as electromagnetic waves (EW). In this way, both the electromagnetic waves (EW) transmitted from the surface are transmitted to the underwater as acoustic optical waves (AW) and the acoustic or optical waves (AW) transmitted from underwater are sent in the form of electromagnetic waves (EW) on the water, and a two-way communication network can be established between the receivers and transmitters on the surface and underwater via the buoy (2).

In one embodiment of the invention, the communication device (1) comprises a surface sensor (5) produced from conductive paint and located on the inner surface (Z) of the buoy (2) in a way that it remains on the water surface (W) in the second state (II). The water surface sensor (5) made of conductive paint is positioned on the inner surface of the buoy (Z) in a way that prevents it from coming into contact with water. In this way, the electromagnetic waves (EW) transmitted through water or ice are prevented from being affected by salty water and causing loss.

In one embodiment of the invention, the communication device (1) comprises at least one trigger sensor (8) that is located on the buoy (2) in connection with the inflation apparatus (3) and triggers the inflation apparatus (3) by detecting the contact of the buoy (2) with water, thus allowing the buoy (2) to be brought from the first state (I) to the second state (II). The buoy (2) is preferably dropped onto water or ice by manned and/or unmanned aerial vehicles while in the first state (I). By means of the trigger sensor (9), the contact of the buoy (2) with water or ice after the fall can be detected. The trigger sensor (9) triggers the inflation apparatus (3) by providing the impact detection function at the moment of contact. In this way, when the buoy (2) touches the water surface (W) or the ice, the trigger sensor (9) activates the inflation apparatus (3) and ensures that air is blown into the buoy (2), and the buoy (2) can be brought to the second state by pumping air into the buoy (2).

In one embodiment of the invention, the communication device (1) comprises at least one keel (10) that is located on the buoy (2) and allows the underwater sensor (6) to remain underwater and the surface sensor (5) to remain above the water in the second state (II), ensuring the centre of gravity created on the water surface (W) with the converter unit (8) to remain stable. The keel (10) provides support to the converter unit (8) which enables the surface sensor (5) to be positioned on the buoy (2) in the second state (II) so that it is almost always above water and the underwater sensor (6) is almost completely and almost always under water, against events that may cause the buoy (2) to rotate around itself, such as waves on the water or ice. The keel (10) is preferably positioned externally from the buoy (2) and in connection with the outer surface (Y) of the buoy (2) when the buoy (2) is in the first state (I) and is placed on the water or ice.

1. A communication device (1) comprising at least one buoy (2) made of flexible material to be positioned on the water surface (W), at least one inflation apparatus (3) that is located on the buoy (2) and allows the buoy (2) to be inflated, a first state (I) of the buoy (2), and a second state (II) in which the buoy (2) is inflated by injecting air into it by means of the inflation apparatus (3) to be positioned on the water surface (W), characterised by the buoy (2) made almost entirely of dielectric material, and at least one reflector (4) that partially covers the inner surface (Z) of the buoy (2) and thus creates a conductive surface that allows the electromagnetic wave (EW) to be detected on the buoy (2) without distortion in the second state (II).

2. A communication device (1) according to claim 1, wherein a reflector (4) that is made of flexible conductive paint and creates a concave dish antenna form on the inner surface (Z) of the buoy (2) in the second state (II), thus creates a surface capable of detecting electromagnetic waves (EW) on the buoy (2) enabling the detection of almost every transmitted electromagnetic wave (EW).

3. A communication device (1) according to claim 1, wherein at least one surface sensor (5) that is located on the buoy (2) and is positioned to remain on the water surface (W) in the second state (II), thus enables the electromagnetic signals transmitted over the water surface (W) to be captured and/or transmitted on the buoy (2).

4. A communication device (1) according to claim 1, wherein at least one underwater sensor (6) that is located on the buoy (2) and is positioned to remain under the water surface (W) in the second state (II), thus enables the acoustic and/or optical waves (AW) transmitted from under the water surface (W) to be captured on the buoy (2) or the transmission of acoustic and/or optical waves (AW) from the buoy (2) to the underwater.

5. A communication device (1) according to claim 3, wherein at least one transmission line (7) that is produced from conductive paint, and enables the transmission of electromagnetic waves (EW) that is captured on the buoy (2) using the surface sensor (5) via the reflector (4) from the inner surface (Z) of the buoy (2).

6. A communication device (1) according to claim 4, wherein at least one transmission line (7) that is produced from conductive paint, and enables the transmission of electromagnetic waves (EW) that is captured on the buoy (2) using the surface sensor (5) via the reflector (4) from the inner surface (Z) of the buoy (2).

7. A communication device (1) according to claim 5, wherein at least one converter unit (8) that enables the electromagnetic waves (EW) carried on the buoy (2) and transmitted to the underwater sensor (6) via the transmission line (7) to be converted into acoustic/optical waves (AW), is located in the inner surface (Z) of the buoy (2) that is opposite to the outer surface (Y) that is in contact with the water in the second state (II), and thus allows the buoy (2) to remain balanced on the water surface by creating the centre of gravity in the second state (II).

8. A communication device (1) according to claim 7, wherein an underwater sensor (6) that allows the detection of acoustic/optical waves (AW) transmitted from under the water surface (W), a converter unit (8) that converts the detected signals transmitted via the underwater sensor (6) into electromagnetic waves (EW), a transmission line (7) that allows the signals converted into electromagnetic waves (EW) to be transmitted to the surface sensor (5), and a buoy (2) that enables the electromagnetic waves (EW) transmitted via the transmission line (7) to be transmitted to the receiver via the surface sensor (5) and thus enables the establishment of an underwater-surface communication network.

9. A communication device (1) according to claim 3, wherein the water surface sensor (5) that is made of conductive paint and is located on the inner surface (Z) of the buoy (2) so that it remains above the water surface (W) in the second state (II).

10. A communication device (1) according to claim 1, wherein at least one trigger sensor (9) that is located on the buoy (2) in connection with the inflation apparatus (3) and triggers the inflation apparatus (3) by detecting the contact of the buoy (2) with water, thus allowing the buoy (2) to be brought from the first state (I) to the second state (II).

11. A communication device (1) according to claim 6, wherein at least one keel (10) that is located on the buoy (2) and allows the underwater sensor (6) to remain underwater and the surface sensor (5) to remain above the water in the second state (II), ensuring the centre of gravity created on the water surface (W) with the converter unit (8) to remain stable.
